(19) United States
(12) Patent Application Publication
(10) Pub. No.: US 2020/0120784 A1
(43) Pub. Date: Apr. 16, 2020

(54) PLASMA GENERATOR INCLUDING ANODE AND CATHODE HELD WITHIN A CONTAINMENT HOUSING

(71) Applicant: University of Kentucky Research Foundation, Lexington, KY (US)

(72) Inventors: Michael Winter, Nicholasville, KY (US); Helmut Koch, Lexington, KY (US)

(21) Appl. No.: 16/599,166

(22) Filed: Oct. 11, 2019

Related U.S. Application Data
(60) Provisional application No. 62/744,377, filed on Oct. 11, 2018.

(51) Int. Cl. H05H 1/34; H01M 4/86; H05H 1/03

(52) U.S. Cl. CPC H05H 1/34; H05H 1/03; H01M 4/8626

(57) ABSTRACT

A plasma generator includes a cylindrical containment housing, an anode in a confinement space within the containment housing and a cathode within the anode. The cylindrical containment housing includes an open end and a closed end. A base forms the closed end. That base includes a first gas inlet and a first gas outlet.

### RELATED APPLICATION

This application claims priority to U.S. Provisional Patent Application 62/744,377 filed on Oct. 11, 2018, which is hereby incorporated by reference in its entirety.

### TECHNICAL FIELD

This document relates generally to the plasma generation field and, more particularly, to a new and improved plasma generator having a containment housing and dedicated gas supply as well as to a related method of generating a plasma from a precursor plasma gas.

### BACKGROUND

This document relates generally to a plasma generator and, more particularly, to an inertial electrostatic confinement plasma generator wherein the outer electrode is confined within a non-conducting mechanical housing and gas for plasma generation is fed into the confinement space within the housing rather than drawn from the environment. The plasma generator uses electrostatic acceleration of ions between two highly porous electrodes to create a plasma inside the inner electrode which is confined there. One or more plasma beams leave the inner electrode to account for space charges built up inside the device.

Advantageously, the plasma generator described herein provides a number of benefits and advantages. The plasma generator is suited for use as a propulsion system for, for example, nanosats and small satellites. More specifically, the operating principle and control over the device is very simple. By its nature, the plasma generator is scalable and may be operated at low power levels down to 20 watts or less with few restrictions in terms of operating gas requirements. Downscaling other propulsion systems to low power and small size typically causes significant losses in performance.

The plasma generator is also suited for material science applications. The hot core plasma produced by the plasma generator is anticipated to be able to decompose even metallic seed materials to the atomic level so that the elements become an integral part of the plasma. The plasma beam leaving the device will carry the seed material with it and deposit the elemental seed material onto a target surface.

This occurs at very low pressure, thereby implying low heat load to the surface to be coated. It is anticipated the resulting film coating will have a higher purity than achieved with faster plasma spray processes.

The plasma generator could also be used in laser ablation processes replacing the laser by the discharged electron beam. The device would allow gentle ablation of the sacrificed material causing a slower film growth with enhanced purity and high quality.

It should be appreciated that the above identified applications are not an exhaustive list and that those skilled in the art will readily recognize other potential applications for this technology.

### SUMMARY

In accordance with the purposes and benefits described herein, a new and improved plasma generator is provided. That plasma generator is of the inertial electrostatic confinement type. That plasma generator comprises a containment housing and, more particularly a cylindrical containment housing having an open end, a closed end and a confinement space within the containment housing. That plasma generator also includes an anode in the confinement space within the containment housing and a cathode within the anode.

The plasma generator may further include a base forming the closed end of the cylindrical housing. That base may include a first gas inlet and a first gas outlet connected to the first gas inlet.

The cathode may be concentrically received within the anode and the anode may be concentrically received within the containment housing. Further, the first gas outlet may be a plurality of openings concentrically arrayed in the base between the anode and the cathode.

The plasma generator may further include a voltage source adapted to apply an electrical potential between the anode and cathode. Further, the plasma generator may include a first gas source delivering a plasma precursor gas to the first gas inlet. Still further, the plasma generator may further include (a) a first electrical terminal carried on the base and connected to the anode and (b) a second electrical terminal carried on the base and connected to the cathode whereby the voltage source is connected to the anode and the cathode.

In one or more of the many possible embodiments of the plasma generator, the plasma generator may further include an end cap received over the open end of the containment housing. That end cap may include an inner rim defining an opening for discharging a plasma beam generated by the plasma generator. In one or more of the many possible embodiments of the plasma generator, the inner rim may engage a distal end of the cathode. Further, in one or more of the many possible embodiments of the plasma generator, the end cap may be integral with the containment housing: that is, the end cap and the outer cylindrical wall of the containment housing may be made from a single piece of material.

In one or more of the many possible embodiments of the plasma generator, the base may further include a second gas inlet and a second gas outlet connected to the second gas inlet. Where the proximal end of the cathode is supported by the base, the second gas outlet may be provided at the proximal end of the cathode. Still further, the plasma generator may further include a second gas source delivering a seed gas to the second gas inlet.

Still further, in one or more of the many possible embodiments, the anode and the cathode may both be electrodes that are cylindrical in shape. More particularly, in one or more of the many possible embodiments the anode may be a first cylindrical helix electrode and the cathode may be a second cylindrical helix electrode.

In accordance with an additional aspect, a new and improved plasma generator is provided comprising: (a) an anode, (b) a cathode wherein the cathode is received inside the anode, and (c) a containment housing and a confinement space within the containment housing. The anode and the cathode are held within the containment housing in the confinement space. The plasma generator also includes a voltage source adapted to apply an electrical potential between the anode and the cathode.

The plasma generator may include a first gas outlet delivering a plasma precursor gas to the confinement space between the anode and the cathode. Further, the plasma generator may include a second gas outlet delivering a seed gas to the confinement space within the cathode. Further, in one or more of the many possible embodiments of the plasma generator, the anode engages an inner wall of the containment housing.

In accordance with yet another aspect, a new and improved method is provided of generating a plasma from a precursor plasma gas in a plasma generator. That method comprises the steps of applying an electrical potential between an anode and cathode held in a confinement space within a containment housing, delivering the plasma precursor gas to the confinement space between the anode and the cathode and forming the plasma within the cathode.

The method may further include the step of discharging an electron, ion and/or plasma beam from an open end of the containment housing. Still further, the method may include the steps of delivering a seed gas to the confinement space inside the cathode, discharging neutrals and ions of the seed gas in the plasma beam and forming a thin film coating from the elements of the seed gas on a target substrate.

In the following description, there are shown and described several preferred embodiments of the plasma generator and the related method of generating a plasma from a precursor plasma gas in a plasma generator. As it should be realized, the plasma generator and the related method are capable of other, different embodiments and their several details are capable of modification in various, obvious aspects all without departing from plasma generator and the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the plasma generator and related method and together with the description serve to explain certain principles thereof. In the drawing figures:

FIG. 1 is a perspective view of a first possible embodiment of the plasma generator.

FIG. 2 is a cross-sectional view of the plasma generator illustrated in FIG. 1.

FIG. 3 is a perspective view of a second possible embodiment of the plasma generator similar to the first possible embodiment but including a lid across the open end of the plasma generator.

FIG. 4 is a cross-sectional view of another alternative embodiment of a plasma generator incorporating two different gas inlets, the first for feeding a primary plasma gas into the confinement space between the anode and the cathode and the second for feeding a seed gas into the confinement space within the cathode.

FIG. 5 is a schematic plan view illustrating the concentric arrangement of the various components of the plasma generator of the embodiment illustrated in FIG. 4.

Reference will now be made in detail to the present preferred embodiments of the plasma generator and related method, examples of which are illustrated in the accompanying drawing figures.

### DETAILED DESCRIPTION

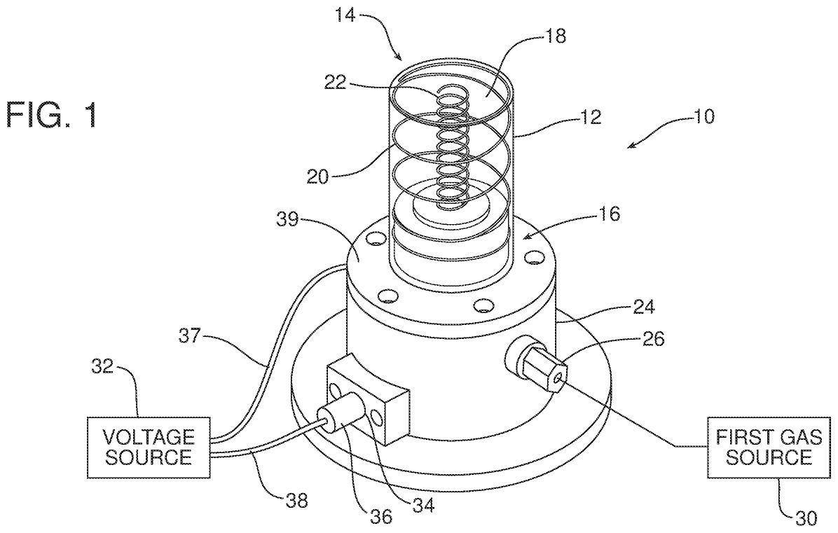

Reference is now made to FIG. 1 illustrating a first possible embodiment of a new and improved plasma generator 10 of the inertial electrostatic confinement type. The plasma generator 10 includes a containment housing 12 having an open end 14, a closed end 16 and a confinement space 18 within the containment housing. The plasma generator 10 also includes an anode 20 in the confinement space 18 within the containment housing 12 and a cathode 22 within the anode.

More particularly, in the illustrated embodiment, the containment housing 12 includes a sidewall that is cylindrical in shape. The containment housing 12 may be a non-conducting mechanical housing made of glass, ceramic or other appropriate material.

In the illustrated embodiment, the anode 20 comprises a first cylindrical helix electrode and the cathode 22 comprises a second cylindrical helix electrode. It should be appreciated that these two cylindrical helix electrodes should be considered as illustrative rather than restrictive in nature and the anode and cathode could assume other shapes if desired. In at least some embodiments, the anode and/or the cathode may be made of wire. The anode and the cathode may both be “highly porous.” By that, it is meant that the anode and the cathode include sufficient open space within their surface area to allow ions to freely react to the electrical field generated between the anode and the cathode rather than to the material of the anode and the cathode. In at least one embodiment, the cathode would comprise at least 50% open space. In at least one embodiment, the cathode would comprise at least 60% open space. In at least one embodiment, the cathode would comprise at least 70% open space. In at least one embodiment, the cathode would comprise at least 80% open space. In at least one embodiment, the cathode would comprise at least 90% open space. In at least one embodiment, the cathode would comprise at least 98% open space.

As also illustrated in FIG. 1, the anode 20 may engage the inner surface of the containment housing 12. This helps to provide support and structural strength to the anode. In other embodiments, the anode 20 may be concentrically spaced inward from the containment housing 12.

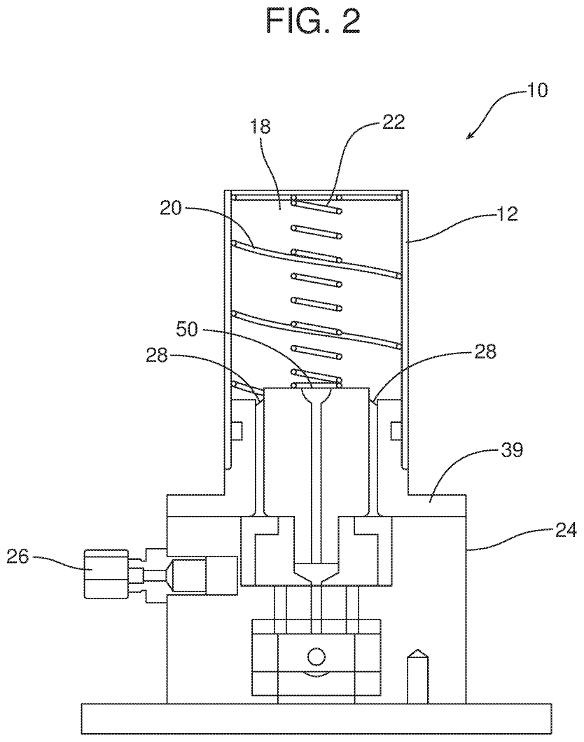

In the illustrated embodiment, a base 24 forms the closed end 16 of the containment housing 12. As illustrated in FIGS. 1 and 2, the base 24 includes a first gas inlet 26 and a first gas outlet 28 connected to the first gas inlet. In the illustrated embodiment, the cathode 22 is concentrically received within the anode 20 and the anode is concentrically received within the containment housing 12. Further, the first gas outlet 28 comprises a plurality of openings concentrically arrayed in the base 24 between the anode 20 and the cathode 22.

A first gas source 30 delivers a plasma precursor gas to the first gas inlet 26. The plasma precursor gas may comprise, but is not necessarily limited to, argon, nitrogen and air. Theoretically, there are no limitations to the nature of the precursor gas so long as gases having demonstrated unacceptable corrosive activity upon electrode materials utilized in the construction of the anode 20 and cathode 22 are avoided.

A voltage source 32 is adapted to apply an electrical potential between the anode 20 and the cathode 22. In the illustrated embodiment, the socket 34 receives a high voltage plug 36 at the end of the lead 38 of the voltage source 32. The socket 34 connects to the cathode 22. A second lead 37 from the voltage source is connected to the aluminum plate 39 at the top of the base 24 at the closed end 16 of the containment housing 12, the aluminum plate making electrical connection to the anode 20. The plasma generator 10 may be operated using direct current (DC) or rectified alternating current (AC).

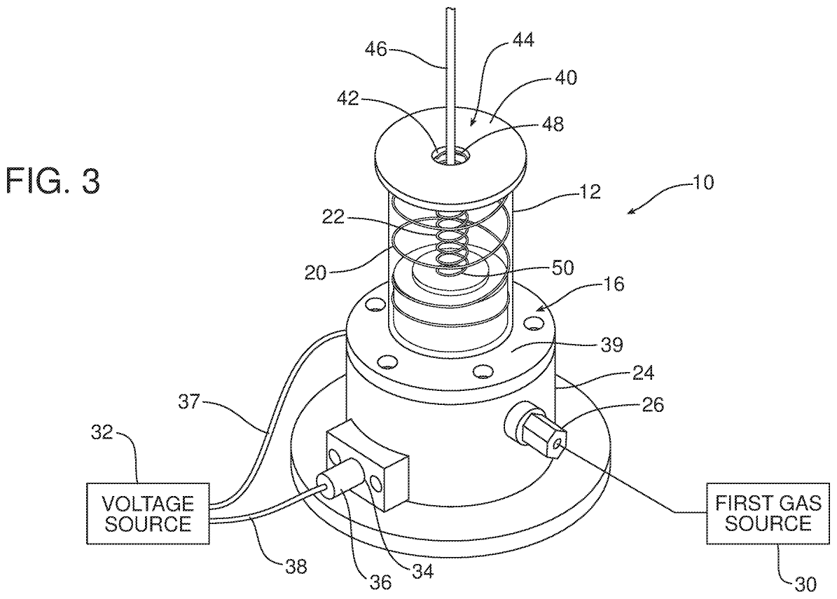

Reference is now made to FIG. 3 illustrating an alternative embodiment of the plasma generator 10. The alternative embodiment of the plasma generator 10 illustrated in FIG. 3 differs from the embodiment of the plasma generator illustrated in FIGS. 1 and 2 by the addition of an end cap 40 received over the open end 14 of the containment housing 12. The shared components are identified by the same reference numbers in FIGS. 1-3. In the illustrated embodiment, the end cap 40 includes an inner rim 42 defining an opening 44 adapted for discharging a plasma beam 46 generated by the plasma generator 10. Such a plasma beam 46 may comprise ions, neutrals and/or electrons.

In the embodiment illustrated in FIG. 3, the inner rim 42 of the end cap 40 engages the distal 48 of the cathode 22 so that the cathode is supported at the distal end by the end cap 40 and at the proximal end 50 by the base 24.

While the end cap 40 in the embodiment illustrated in FIG. 3 is a separate structure connected to the containment housing 12, it should be appreciated that the end cap 40 may be formed as an integral one-piece structure with the containment housing 12 if desired.

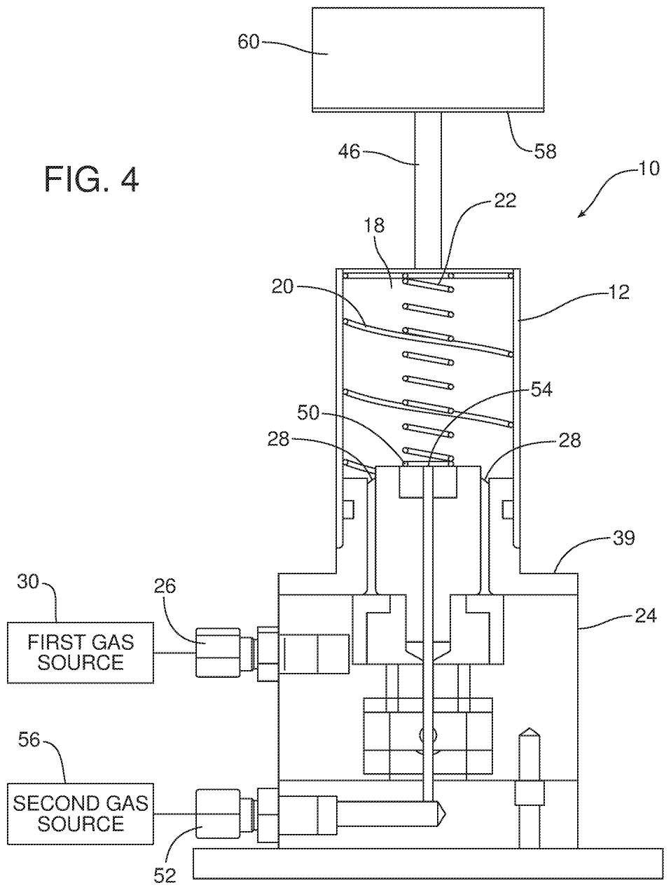

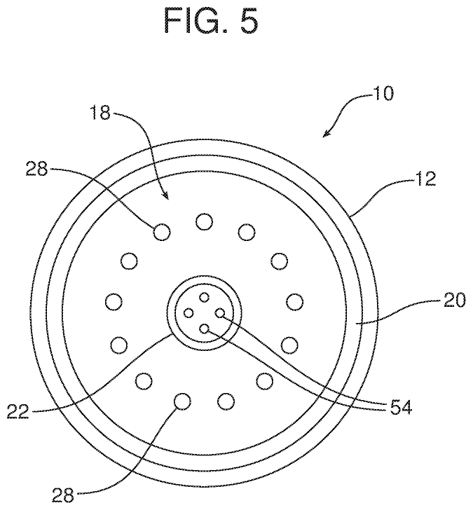

Reference is now made to an additional alternative embodiment of the plasma generator 10 illustrated in FIGS. 4 and 5. The plasma generator 10 illustrated in FIGS. 4 and 5 is similar in many respects to the plasma generator 10 illustrated in FIGS. 1, 2 and 3 and those shared components are identified by the same reference numbers. The embodiment of the plasma generator 10 illustrated in FIGS. 4 and 5 differs from the previous embodiments by the incorporation of a second gas inlet 52 provided in the base 24 and a second gas outlet 54 connected to or in communication with the second gas inlet. In addition, a second gas source 56 is connected to the second gas inlet. That second gas source 56 may provide a seed gas for forming a thin film coating on a target substrate in a manner that will be described in greater detail below. Such a seed gas may comprise substantially any appropriate gas containing desired seed particles except for those demonstrating unacceptable corrosive activity upon electrode materials utilized in the construction of the anode 20 and the cathode 22.

In the illustrated embodiment, the second gas outlet 54 comprises one or more apertures in the base oriented and adapted to deliver the seed gas to the confinement space inside the cathode 22. Note, for example, the single opening 54 in FIG. 4. In FIG. 5, the precursor gas is delivered through the first gas outlet 28 in the form of the plurality of apertures defined in the base 24 between the anode 20 and the cathode 22 while the seed gas is delivered through the second gas outlet (note four openings) into the confinement space within the cathode 22.

As should be appreciated, the various embodiments of the plasma generator 10 illustrated in drawing FIGS. 1-5 and described above are useful in a method of generating a plasma from a precursor plasma gas. That method may be broadly described as comprising the steps of: (a) applying an electrical potential between an anode 20 and a cathode 22 held in a confinement space 18 within a containment housing 12, (b) delivering a plasma precursor gas to the confinement space between the anode and the cathode and (c) forming the plasma within the cathode 22.

The method may further include the step of discharging a plasma beam 46 from the open end 14 of the containment housing 12. Further, with respect to the embodiment of the plasma generator 10 illustrated in FIG. 4, the method also includes the steps of delivering a seed gas to the confinement space 18 inside the cathode 22, discharging elements of the seed gas in the plasma beam 46 and forming a thin film coating 58 from the elements of the seed gas on a target substrate 60.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A plasma generator, comprising:
a cylindrical containment housing having an open end, a closed end and a confinement space within said containment housing;
an anode in said confinement space within said cylindrical containment housing; and
a cathode within said anode.

2. The plasma generator of claim 1, further including a base forming the closed end of the cylindrical containment housing, said base including a first gas inlet and a first gas outlet connected to said first gas inlet.

3. The plasma generator of claim 2, wherein said cathode is concentrically received within said anode and said anode is concentrically received within said cylindrical containment housing.

4. The plasma generator of claim 3 wherein said first gas outlet is a plurality of openings concentrically arrayed in said base between said anode and said cathode.

5. The plasma generator of claim 4, further including a voltage source adapted to apply an electrical potential between said anode and said cathode.

6. The plasma generator of claim 5, further including a first gas source delivering a plasma precursor gas to said first gas inlet.

7. The plasma generator of claim 6, further including an end cap received over the open end of said cylindrical containment housing, said end cap including an inner rim defining an opening through which a beam generated by the plasma generator is discharged.

8. The plasma generator of claim 7, wherein said inner rim engages a distal end of the cathode.

9. The plasma generator of claim 6, wherein said base further includes a second gas inlet and a second gas outlet connected to said second gas inlet.

10. The plasma generator of claim 9, wherein a proximal end of said cathode is supported by said base and said second gas outlet is provided at said proximal end of said cathode.

11. The plasma generator of claim 10, further including a second gas source delivering a seed gas to said second gas inlet.

12. The plasma generator of claim 2, wherein said anode is a first cylindrical helix electrode and said cathode is a second cylindrical helix electrode.

13. A plasma generator, comprising:
an anode;
a cathode wherein said cathode is received inside said anode;
a containment housing and a confinement space within said containment housing, said anode and said cathode being held within said containment housing in said confinement space; and
a voltage source adapted to apply an electrical potential between the anode and the cathode.

14. The plasma generator of claim 13, further including a first gas outlet delivering a plasma precursor gas to the confinement space between the anode and the cathode.

15. The plasma generator of claim 14, further including a second gas outlet delivering a seed gas to said confinement space within said cathode.

16. The plasma generator of claim 15, wherein said anode engages an inner wall of said containment housing.

17. A method of generating a plasma from a precursor plasma gas in a plasma generator, comprising:
applying an electrical potential between an anode and a cathode held in a confinement space within a containment housing wherein the anode is a first cylindrical electrode and the cathode is a second cylindrical electrode;
delivering the plasma precursor gas to the confinement space between the anode and the cathode; and
forming the plasma within the cathode.

18. The method of claim 17, further including discharging an electron, ion, and/or plasma beam from an open end of the containment housing.

19. The method of claim 18, including delivering a seed gas to the confinement space inside the cathode, discharging neutrals and ions of the seed gas in the plasma beam and forming a film coating from the ions of the seed gas on a target substrate.
